(19) United States
(12) Patent Application Publication
(10) Pub. No.: US 2004/0099112 A1
(43) Pub. Date: May 27, 2004

(54) Plate-like carrying mechanism and dicing device with carrying mechanism

(76) Inventors: Naoki Ohmiya, Tokyo (JP); Satoshi Tateiwa, Tokyo (JP)

Correspondence Address: Smith Gambrell & Russell, Suite 800, 1850 M Street NW, Washington, DC, 20036, US

(21) Appl. No.: 10/472,693

(22) PCT Filed: Feb. 10, 2003
(86) PCT No.: PCT/JP03/01360

(30) Foreign Application Priority Data
Feb. 15, 2002 (JP) 2002-038682

(51) Int. Cl. B26D 7/06

(52) U.S. Cl. 83/100

(57) ABSTRACT

A conveying apparatus for conveying a plate-like object that is affixed to the top surface of a protective tape mounted to cover the inside opening of a support frame formed in an annular form, comprising a suction-holding member having a negative pressure chamber which is open at the bottom and an annular contact portion to be contacted to the top surface of the support frame on the under surface, the negative pressure chamber being connected to a suction-source; and a moving unit for moving the suction-holding member between a first predetermined position and a second predetermined position.

### TECHNICAL FIELD

The present invention relates to a conveying apparatus for conveying a plate-like object such as a semiconductor wafer or the like that is adhered to a protective tape mounted to an annular support frame, and to a dicing machine equipped with the same.

### BACKGROUND ART

In the production process of semiconductor devices, for example, individual semiconductor chips are produced by forming a circuit such as IC, LSI or the like in a large number of areas arranged in a lattice form on the front surface of a semiconductor wafer that is a substantially disk-like object and dividing the semiconductor wafer into the circuit-formed areas along cutting lines called “streets” by using a dicing machine. To use the semiconductor wafer effectively, how small the cutting width for dividing can be made is important. As a dividing machine for dividing the semiconductor wafer, generally, a dicing machine is used, and cuts the semiconductor wafer with a cutting blade having a thickness of about 15 μm. Further, a method for forming individual semiconductor chips by giving a shock to cutting lines formed in the semiconductor wafer by using a laser beam to split the cutting lines is also employed. In the case where the semiconductor wafer is to be divided by a dicing machine, as described above, it is supported to a support frame by a protective tape so that the divided semiconductor chips do not separate from one another. The support frame has an opening and a tape-affixing portion to which a protective tape is affixed, and is formed in an annular shape, and the semiconductor wafer is affixed to, and supported on, the protective tape positioning on the opening. Thus, a plurality of semiconductor chips produced by dividing the semiconductor wafer that is supported on the support frame by the protective tape are conveyed to the subsequent step by a conveying apparatus having a holding means for suction-holding the support frame, in a state of the semiconductor wafer being supported onto the support frame by the protective tape.

Since the semiconductor wafer is thus formed from a fragile material, it has a problem that when the plurality of semiconductor chips produced by dividing the semiconductor wafer are conveyed while the support frame is suction-held, adjacent semiconductor chips are damaged or broken by their contact due to the deflection of the protective tape.

Further, as electric equipment which uses semiconductor chips have been becoming smaller in size and lighter in weight, it is desired that the semiconductor wafer be processed to a thickness of preferably 100 μm or less, more preferably 50 μm or less. Therefore, a semiconductor wafer which has been ground to a thickness of 100 μm or less to 50 μm or less is supported to a support frame by a protective tape and conveyed to a processing machine such as a dicing machine. When the semiconductor wafer is conveyed while the support frame is suction-held, it is curved by the deflection of the protective tape, thereby generating stress in the semiconductor wafer.

It is the principal object of the present invention that has been made in view of the above facts to provide a conveying apparatus capable of conveying a plate-like object such as a semiconductor wafer that is affixed to a protective tape mounted to a support frame without damaging it, and a dicing machine equipped with this conveying apparatus.

### DISCLOSURE OF THE INVENTION

To attain the above principal object of the present invention, according to the present invention, there is provided a conveying apparatus for conveying a plate-like object that is affixed to the top surface of a protective tape mounted to cover the inside opening of a support frame formed in an annular form, comprising:

a suction-holding member having a negative pressure chamber which is open at the bottom and an annular contact portion to be contacted with the top surface of the support frame on the under surface, the negative pressure chamber being connected to a suction-source; and

a moving unit for moving the suction-holding member between a first predetermined position and a second predetermined position.

Preferably, the pressure of the above negative pressure chamber is set to a value lower than atmospheric pressure by 1 to 5 kPa. Preferably, a plurality of suction pads for suction-holding the top surface of the support frame are arranged outside in a radial direction of the suction-holding member. The above plate-like object is a semiconductor wafer and divided into a plurality of chips.

According to the present invention, there is also provided a dicing machine comprising:

a cassette placing portion for placing a cassette for storing a semiconductor wafer that is affixed to the top surface of a protective tape mounted to cover the inside opening of a support frame formed in an annular form;

a carrying-out means for conveying the semiconductor wafer out that is placed on the cassette placing portion, stored in the cassette and supported to the support frame by the protective tape;

a temporary placing area for temporarily placing the semiconductor wafer that is carried out from the cassette by the carrying-out means and supported to the support frame by the protective film;

a first conveying apparatus for conveying the semiconductor wafer that is placed on the temporary placing area and supported to the support frame by the protective tape, to a chuck table;

a dicing means for dividing the semiconductor wafer held on the chuck table and supported to the support frame by the protective tape into individual chips;

a second conveying apparatus for conveying the semiconductor wafer that has been divided into individual chips by the dicing means and supported to the support frame by the protective tape, to a cleaning means; and

a third conveying apparatus for conveying the semiconductor wafer that has been cleaned by the cleaning means, divided into individual chips and supported to the support frame by the protective tape, to the temporary placing area, wherein

the second conveying apparatus comprises:

a suction-holding member having a negative pressure chamber which is open at the bottom and an annular contact portion to be contacted to the top surface of the support frame on the under surface, the negative pressure chamber being connected to a suction-source; and

a moving unit for moving the suction-holding member between a first predetermined position and a second predetermined position.

Further, according to the present invention, there is provided a dicing machine, wherein the third conveying apparatus comprises:

a suction-holding member having a negative pressure chamber which is open at the bottom and an annular contact portion to be contacted to the top surface of the support frame on the under surface, the negative pressure chamber being connected to a suction-source; and

a moving unit for moving the suction-holding member between a first predetermined position and a second predetermined position.

Preferably, the above third conveying apparatus has the function of the above first conveying apparatus for conveying the semiconductor wafer that is placed on the above temporary placing area and supported to the support frame by the protective tape, to a chuck table.

### BRIEF DESCRIPTION OF THE DRAWINGS

FIG. 1 is a perspective view of a cutting machine as a dicing machine equipped with a conveying apparatus for a plate-like object constituted according to the present invention;

FIG. 2 is a perspective view of a first conveying apparatus as the conveying apparatus constituted according to the present invention;

FIG. 3 is a sectional view showing the first use mode of the conveying apparatus constituted according to the present invention;

FIG. 4 is a sectional view showing the second use mode of the conveying apparatus constituted according to the present invention; and

FIG. 5 is a perspective view of a second conveying apparatus as the conveying apparatus constituted according to the present invention.

### BEST MODE FOR CARRYING OUT THE INVENTION

Preferred embodiments of a conveying apparatus for a plate-like object and a dicing machine equipped with this conveying apparatus constituted according to the present invention will be described in detail hereinafter with reference to the accompanying drawings.

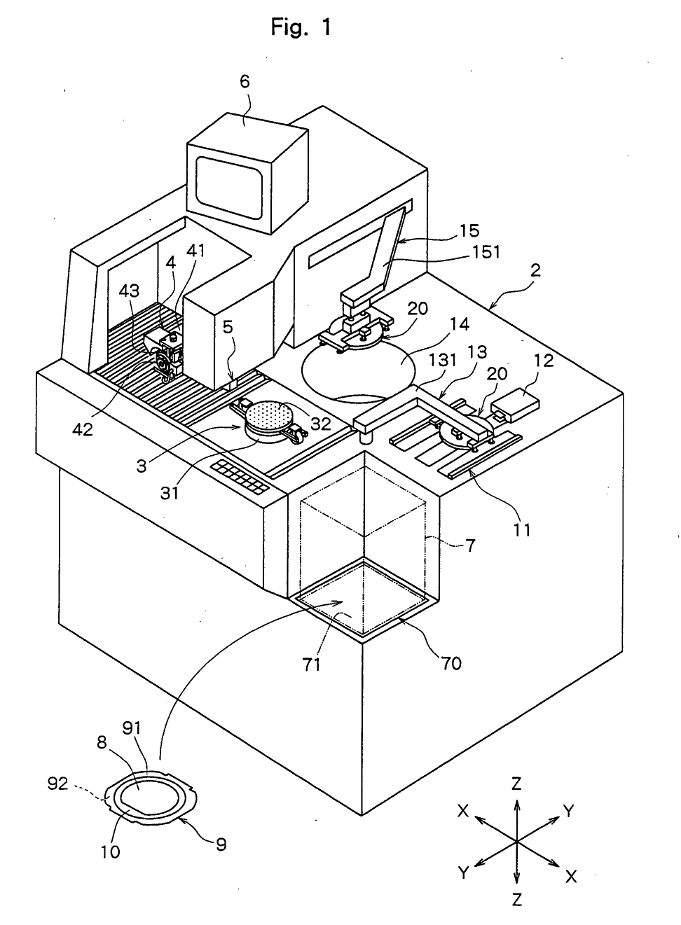

FIG. 1 is a perspective view of a cutting machine as a dicing machine equipped with a conveying apparatus for a plate-like object constituted according to the present invention.

The cutting machine in the illustrated embodiment has a substantially rectangular parallelepiped housing 2. In this housing 2, a chuck table 3 for holding a workpiece is installed in such a manner that it can move in a direction shown by an arrow X that is a cutting-feed direction. The chuck table 3 comprises an adsorption chuck base 31 and an adsorption chuck 32 mounted on the adsorption chuck base 31, and a workpiece, for example, a disk-like semiconductor wafer is suction-held on the placing surface that is the surface of the adsorption chuck 32 by a suction means (not shown). The chuck table 3 is constituted to be able to turn by a rotation unit that is not shown.

The cutting machine in the illustrated embodiment has a spindle unit 4 as the cutting means. This spindle unit 4 comprises a spindle housing 41 which is mounted on a movable base (not shown) and moved in a direction shown by an arrow Y that is an indexing direction and in a direction shown by an arrow Z that is a cutting direction, a rotary spindle 42 that is rotatably supported to the spindle housing 41 and is driven by a rotary drive device that is not shown, and a cutting blade 43 attached to the rotary spindle 42.

The cutting machine in the illustrated embodiment comprises an imaging unit 5 that images the front surface of the workpiece held on the surface of the adsorption chuck 32 constituting the above chuck table 3 to detect an area to be cut with the above cutting blade 43 or to confirm the state of a cut groove. This imaging unit 5 is an optical means such as a microscope, CCD camera or the like. The dicing machine further comprises a display means 6 for displaying an image taken by the imaging unit 5.

The cutting machine in the illustrated embodiment has a cassette 7 for storing the semiconductor wafer 8 as the workpiece. Here, a description is given of the relationship among the semiconductor wafer 8 as the workpiece, the support frame 9 and the protective tape 10. The support frame 9 is formed from a metal material such as stainless steel or the like in an annular shape, and has an opening 91 and a tape-affixing portion 92 to which the protective tape 10 is affixed (formed on the back surface in the state of FIG. 1). The protective tape 10 has an adhesive layer on the top surface and is mounted on the tape-affixing portion 92 so as to cover the above opening 91, and the semiconductor wafer 9 is affixed on the top surface of the protective tape 10. Thus, the semiconductor wafer 8 supported to the support frame 9 through the protective tape 10 is stored in the above cassette 7. The cassette 7 is placed on a cassette table 71 in a cassette placing portion 70 in such a manner that it can be moved vertically by a lifting means that is not shown.

The cutting machine in the illustrated embodiment comprises a workpiece carrying-out means 12 for conveying the semiconductor wafer 8 (in a state of being supported onto the support frame 9 by the protective tape 10) as the workpiece stored in the cassette 7 to a temporary placing area 11, a first conveying apparatus 13 for conveying the semiconductor wafer 8 carried out by the workpiece carrying-out means 12 to the top of the above chuck table 3, a cleaning means 14 for cleaning the semiconductor wafer 8 cut-processed on the chuck table 3, and a second conveying apparatus 15 for conveying the semiconductor wafer 8 cut-processed on the chuck table 3 to the cleaning means 14. In the illustrated embodiment, the above first conveying apparatus 13 has the function as a third conveying apparatus for conveying the semiconductor wafer 8 cleaned by the cleaning means 14 to the above temporary placing area 11.

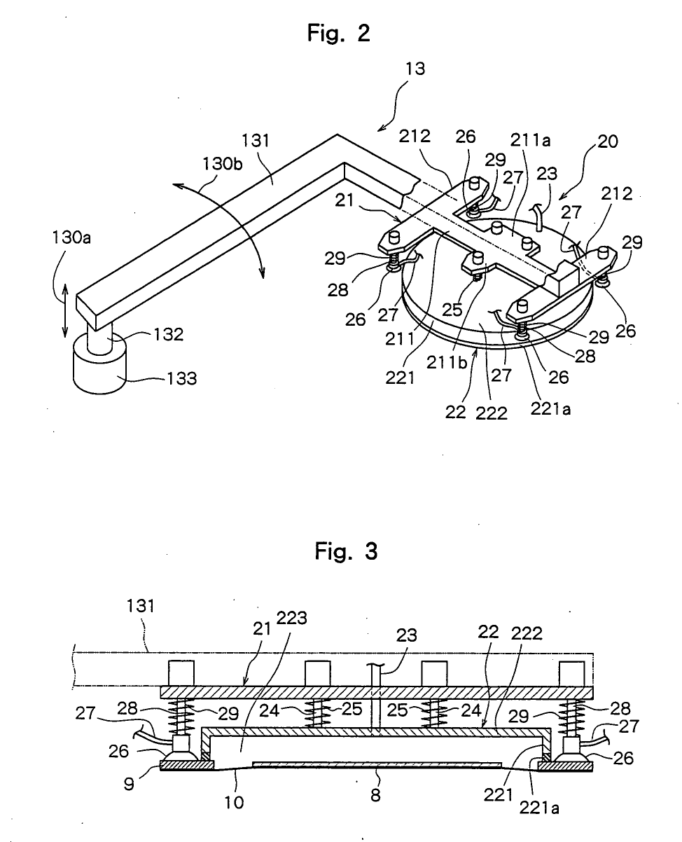

A description is subsequently given of the above first conveying apparatus 13 with reference to FIG. 2 and FIG. 3.

The first conveying apparatus 13 in the illustrated embodiment has an L-shaped working arm 131. One end of this L-shaped working arm 131 is connected to a lifting means 132. The lifting means 132 is constituted by, for example, an air piston or the like, which moves the working arm 131 in a vertical direction as shown by an arrow 130a in FIG. 2. The lifting means 132 connected to one end of the working arm 131 is connected to a moving unit 133 having an electric motor that can run in a normal rotation direction and reverse rotation direction. Accordingly, the working arm 131 is caused to swing in a direction shown by an arrow 130b in FIG. 2 on the lifting means 132 as the center by driving the moving unit 133 in a normal direction or reverse direction. As a result, the working arm 131 is operated within the horizontal plane, and a suction-holding unit 20, which is to be mounted to the other end of the working arm 131 and will be later described, is moved between the temporary placing area 11 and the above chuck table 3 or the above cleaning means 14 within the horizontal plane.

The suction-holding unit 20 mounted to the other end of the above working arm 131 has a support member 21 which is mounted to the under surface of the other end portion of the working arm 131. This support member 21 is shaped like a letter H and consists of a center support portion 211 and both side support portions 212 and 212 that are formed at both ends of the center support portion 211 and extend in a direction perpendicular to the center support portion 211.

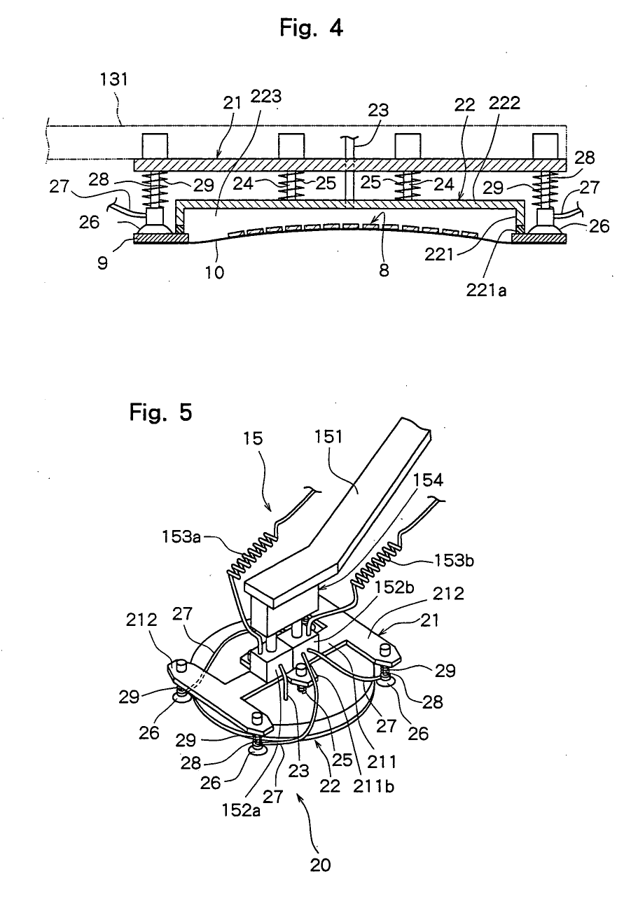

The center support portion 211 constituting the above support member 21 is provided with attachment portions 211a and 211b. A suction-holding member 22 for suction-holding the top surface of the support frame 9 for supporting the above semiconductor wafer 8 by the protective tape 10 is disposed to the attachment portions 211a and 211b. The suction-holding member 22 has an annular side wall 221 and a top wall 222 as shown in FIG. 3 and FIG. 4 and is formed in a shape of a cup having a circular negative pressure chamber 223 that is open at the bottom. The under surface of the annular side wall 221 functions as a contact portion to be contacted with the support frame 9. In the illustrated embodiment, the under surface of the annular side wall 221 is provided with an annular seal member 221a made from rubber or the like. Therefore, in the illustrated embodiment, the annular seal member 221a functions as a contact portion to be contacted with the support frame 9. The negative pressure chamber 223 of the suction-holding member 22 is connected with a suction means (not shown) through a flexible pipe 23 so as to properly communicate with a suction-source. The pressure of the suction-source connected to the negative pressure chamber 223 of the suction-holding member 22 is set to a value lower than atmospheric pressure by 1 to 5 KPa. The thus constituted suction-holding member 22 is attached to the lower ends of support rods 24, 24 and 24, which are fitted in the above attachment portions 211a and 211b in such a manner that they can slide in a vertical direction, and is urged to be pressed downward by coil springs 25, 25 and 25 arranged between the suction-holding member 22 and the under surfaces of the attachment portions 211a and 211b.

The suction-holding unit 20 in the illustrated embodiment has a plurality of suction pads 26, 26, 26 and 26 (4 pads in the illustrated embodiment), arranged outside in the radial direction of the above suction-holding member 22, for suction-holding the top surface of the support frame 9. These suction pads 26, 26, 26 and 26 may be conventionally known suction pads, and are respectively arranged at both sides of the both side support portions 212 and 212 of the above support member 21 and connected to a suction means (not shown) via respective flexible pipes 27, 27, 27 and 27 to properly communicate with a suction-source, respectively. The pressure of the suction-source-connected to the suction pads 26, 26, 26 and 26 is set to a value lower than atmospheric pressure by about 70 KPa. The above flexible pipes 27, 27, 27 and 27 are desirably laid inside the above working arm 131 or along the working arm 131. The suction pads 26, 26, 26 and 26 are mounted to the lower ends of support rods 28, 28, 28 and 28 which are fitted in the both side support portions 212 and 212 in such a manner that they can slide in a vertical direction, and are urged to be pressed downward by coil springs 29, 29, 29 and 29 arranged between the suction pads and the under surfaces of the both side support portions 212 and 212.

A description is subsequently given of the second conveying apparatus 15 with reference to FIG. 5.

The second conveying apparatus 15 in the illustrated embodiment has a working arm 151. One end of this working arm 151 is connected to a reciprocating moving mechanism (not shown) that has been conventionally used. Therefore, a suction-holding unit 20, that will be described later and is to be attached to the other end of the working arm 151, is moved between the above cleaning means 15 and the above chuck table 3 within the horizontal plane.

The suction-holding unit 20 attached to the other end of the above working arm 151 comprises a support member 21, a suction-holding member 22 arranged to the support member 21, and suction pads 26, 26, 26 and 26 arranged outside in the radial direction of the suction-holding member 22. The suction-holding unit 20 is substantially the same in constitution as the suction-holding unit 20 of the first conveying apparatus 13 shown in FIGS. 2, 3 and 4 and therefore, the same members have the same reference symbols and their descriptions are omitted.

On top of the center support portion 211 constituting the support member 21 of the suction-holding unit 20, there are two vacuum distributors 152a and 152b. These two vacuum distributors 152a and 152b are connected to a suction means (not shown) by flexible pipes 153a and 153b so that they properly communicate with suction-sources, respectively. The pressure of a suction-source connected to one vacuum distributor 152a is set to a value lower than atmospheric pressure by 1 to 5 KPa and the pressure of a suction-source connected to the other vacuum distributor 152b is set to a value lower than atmospheric pressure by 70 KPa. One vacuum distributor 152a is connected to the negative pressure chamber 223 (see FIG. 3) of the suction-holding member 22 by a flexible pipe 23 and the other vacuum distributor 152b is connected to the four suction pads 26, 26, 26 and 26 by flexible pipes 27, 27, 27 and 27, respectively. A lifting means 154 is interposed between the vacuum distributors 152a and 152b mounted on the support member 21 and the above working arm 151. This lifting means 154 is constituted by, for example, an air piston or the like.

The cutting machine as a dicing machine equipped with the conveying apparatus for a plate-like object constituted according to the present invention is constituted as described above, and its operation will be described with reference to FIG. 1.

The semiconductor wafer 8 that is stored at a predetermined position of the cassette 7 and is in a state of being supported to the support frame 9 by the tape 10 (the semiconductor wafer 8 supported to the support frame 9 by the tape 10 will be simply referred to as “semiconductor wafer 8” hereinafter) is brought to a carrying-out position by the up and down movement of the cassette table 71 by a lifting means that is not shown. The semiconductor wafer 8 positioned at the carrying-out position is then carried to the temporary placing area 11 by the advance or retreat motion of the workpiece carrying-out means 12. The semiconductor wafer 8 carried to the temporary placing area 11 is suction-held to the suction-holding unit 20 by the operations of the lifting means 132 and the moving unit 133 constituting the first conveying apparatus 13 and a suction means that is not shown, and is conveyed onto a placing surface of the adsorption chuck 32 constituting the chuck table 3. At this point, the suction-holding unit 20 constituting the first conveying apparatus 13 suction-holds the semiconductor wafer 8 in such a manner that the top surface of the support frame 9 supporting the semiconductor wafer 8 by the protective tape 10 comes into contact with the under surface of the annular seal member 221a constituting the suction-holding member 22 as shown in FIG. 3 and concurrently, the top surface of the support frame 9 is suction-held by the four suction pads 26, 26, 26 and 26. When the support frame 9 is thus suction-held by the suction-holding unit 20, the protective tape 10 affixed to the semiconductor wafer 8 is also suction-held by negative pressure applied to the negative chamber 223 of the suction-holding member 22. Therefore, since the protective tape 10 is not hung down by the gravity of the semiconductor wafer 8, even when the thickness of the semiconductor wafer 8 is reduced to 100 or 50 μm or less by grinding, the semiconductor wafer 8 is not curved by the deflection of the protective tape 10 at the time when the semiconductor wafer 8 is conveyed, thereby making it possible to prevent stress generated by curvature in advance. In the suction-holding by this suction-holding member 22, although greater suction-holding force is obtained as negative pressure applied to the negative pressure chamber 223 increases, it is desired to set the suction-holding force to an appropriate value because a force for curving the semiconductor wafer 8 to the opposite side (the center portion is curved upward) becomes large. According to experiments conducted by the inventors of the present invention, it was found that negative pressure applied to the negative pressure chamber 223 of the suction-holding member 22 is suitably a value lower than atmospheric pressure by 1 to 5 KPa. In the illustrated embodiment, as the frame 9 supporting the semiconductor wafer 8 is suction-held by the suction-holding unit 20 and the four suction pads 26, 26, 26 and 26, its holding is secured.

The semiconductor wafer 8 that has been conveyed to the top of the adsorption chuck 32 of the chuck table 3 by the first conveying apparatus is released from the suction-holding by the suction-holding unit 20 and the four suction pads 26, 26, 26 and 26 constituting the first conveying apparatus 13 and then, is suction-held to the adsorption chuck 32. Thus, the chuck table 3 that suction-holds the semiconductor wafer 8 is caused to move right below the imaging unit 5. When the chuck table 3 is positioned right below the imaging unit 5, the cutting lines formed in the semiconductor wafer 8 are detected by the imaging unit 5, and the spindle unit 3 is moved in the direction shown by the arrow Y that is the indexing direction, to carry out a precision alignment work.

Thereafter, the chuck table 3 that suction-holds the semiconductor wafer 8 is moved in the direction shown by the arrow X that is the cutting-feed direction (direction perpendicular to the rotary shaft of the cutting blade 43) at a cutting-feed rate of 30 mm/sec, for example, while the cutting blade is rotated in a predetermined direction so that the semiconductor wafer 8 held on the chuck table 3 is cut along predetermined cutting lines, with the cutting blade 43. That is, since the cutting blade 43 is attached to the spindle unit 4 which is positioned by being moved for adjustment in the direction shown by the arrow Y that is the indexing direction and in the direction shown by the arrow Z that is the cutting direction, and driven to be rotated. Thereby, the semiconductor wafer 8 held on the chuck table 3 is cut along the predetermined cutting lines with the cutting blade by moving the chuck table 3 in the cutting-feed direction along below the cutting blade 43. When the semiconductor wafer 8 is cut along the cutting lines, it is divided into individual semiconductor chips. The divided semiconductor chips do not separate from one another by the function of the protective tape 10 and the state of the semiconductor wafer 8 supported to the support frame 9 is maintained. After the cutting of the semiconductor wafer 8 is thus over, the chuck table 3 holding the semiconductor wafer 8 is returned to a position where it has initially suction-held the semiconductor wafer 8, and the suction-holding of the semiconductor wafer 8 is canceled there.

Thereafter, the semiconductor wafer 8 which has been divided into individual semiconductor chips and has been released from the suction-holding on the chuck table 3 is suction-held to the suction-holding unit 20 by the operations of the lifting means 154 constituting the second conveying apparatus 15, a reciprocating moving mechanism (not shown) and a suction means and conveyed to the above cleaning means 14. At this point, the suction-holding unit 20 constituting the second conveying apparatus 15 suction holds the semiconductor wafer 8 in such a manner that the under surface of the annular seal member 221a of the suction-holding member 22 comes into contact with the top surface of the support frame 9 supporting the semiconductor wafer 8 by the protective tape 10 and concurrently, the top surface of the support frame 9 is suction-held by the four suction pads 26, 26, 26 and 26, like the suction-holding unit 20 of the above first conveying apparatus 13. When the support frame 9 is thus suction-held by the suction-holding unit 20, the protective tape 10 affixed to the semiconductor wafer 8 that has been divided into individual semiconductor chips is also suction-held by negative pressure applied to the negative pressure chamber 223 of the suction-holding member 22, as shown in FIG. 4. As a result, as the center portion of the protective tape 10 is raised and gaps between adjacent divided semiconductor chips of the semiconductor wafer 8 are maintained, contact between semiconductor chips is prevented. Therefore, loss or damage caused by contact to one another between semiconductor chips can be prevented.

Contaminants produced by the cutting are removed from the semiconductor wafer 8 that has been divided into individual semiconductor chips and conveyed to the cleaning means 14, by the cleaning means 14 as described above. The semiconductor wafer 8 cleaned by the cleaning means 14 is conveyed to the above temporary placing area 11 by the above first conveying apparatus 13 which functions as a third conveying apparatus. At this point, the suction-holding unit 20 constituting the first conveying apparatus 13 suction-holds the semiconductor wafer 8 in such a manner that the under surface of the annular seal member 221a of the suction-holding member 22 comes into contact with the top surface of the support frame 9 supporting the semiconductor wafer 8 by the protective tape 10 as shown in FIG. 4 and concurrently, the top surface of the support frame 9 is suction-held by the four suction pads 26, 26, 26 and 26, like the suction-holding unit 20 of the above second conveying apparatus 15. Accordingly, since the protective tape 10 affixed to the semiconductor wafer 8 that has been divided into individual semiconductor chips is also suction-held by negative pressure applied to the negative pressure chamber 223 of the suction-holding member 22 as described above and the center portion of the protective tape 10 is raised, gaps between adjacent semiconductor chips are maintained and contact between adjacent semiconductor chips is prevented, thereby making it possible to prevent lost or damage caused by contact between semiconductor chips. The semiconductor wafer 8 conveyed to the temporary placing area 11 is stored at a predetermined position of the cassette 7 by the workpiece carrying-out means 12.

### Industrial Utilization Feasibility

Since the conveying apparatus for a plate-like object of the present invention and the cutting machine as a dicing machine having the conveying apparatus of the present invention are constituted as described above, they give the following functions and effects.

That is, the conveying apparatus for a plate-like object of the present invention comprises a suction-holding unit having a suction-holding member comprising a negative pressure chamber which is open at the bottom and an annular contact portion to be contacted to the top surface of a support frame on the under surface, the negative pressure chamber being connected to a negative pressure source, and a plate-like object holding means for suction-holding the top surface of a plate-like object supported to the support frame by a protective tape. Therefore, when the support frame is suction-held, the protective tape affixed to the plate-like object is also suction-held by negative pressure applied to the negative pressure chamber of the suction-holding member. Accordingly, even when the plate-like object is extremely thin or when it is divided into a plurality of chips, it is not curved and the chips are not contacted to one another due to the deflection of the protective tape at the time when it is conveyed being suction-held, thereby making it possible to convey the plate-like object without being damaged.

1. A conveying apparatus for conveying a plate-like object that is affixed to the top surface of a protective tape mounted to cover the inside opening of a support frame formed annular, comprising:
a suction-holding member having a negative pressure chamber which is open at the bottom and an annular contact portion to be contacted to the top surface of the support frame on the under surface, the negative pressure chamber being connected to a suction-source; and
a moving unit for moving the suction-holding member between a first predetermined position and a second predetermined position.

2. The conveying apparatus for conveying a plate-like object according to claim 1, wherein the pressure of the negative pressure chamber is set to a value lower than atmospheric pressure by 1 to 5 KPa.

3. The conveying apparatus for conveying a plate-like object according to claim 1, wherein a plurality of suction pads for suction-holding the top surface of the support frame are arranged outside in a radial direction of the suction-holding member.

4. The conveying apparatus for conveying a plate-like object according to claim 1, wherein the plate-like object is a semiconductor wafer and divided into a plurality of chips.

5. A dicing machine comprising:
a cassette placing portion for placing a cassette for storing a semiconductor wafer that is affixed to the top surface of a protective tape mounted to cover the inside opening of a support frame formed in an annular form;
a carrying-out means for carrying the semiconductor wafer out which is placed on the cassette placing portion, stored in the cassette and supported to the support frame by the protective tape;
a temporary placing area for temporarily placing the semiconductor wafer which is carried out from the cassette by the carrying-out means and supported to the support frame by the protective film;
a first conveying apparatus for conveying the semiconductor wafer that is placed on the temporary placing area and supported to the support frame by the protective tape, to a chuck table;
a dicing means for dividing the semiconductor wafer held on the chuck table and supported to the support frame by the protective tape into individual chips;
a second conveying apparatus for conveying the semiconductor wafer that has been divided into individual chips by the dicing means and supported to the support frame by the protective tape, to a cleaning means; and
a third conveying apparatus for conveying the semiconductor wafer that has been cleaned by the cleaning means, divided into individual chips and supported to the support frame by the protective tape, to the temporary placing area, wherein
the second conveying apparatus comprises:
a suction-holding member having a negative pressure chamber which is open at the bottom and an annular contact portion to be contacted to the top surface of the support frame on the under surface, the negative pressure chamber being connected to a suction-source; and
a moving unit for moving the suction-holding member between a first predetermined position and a second predetermined position.

6. A dicing machine comprising:
a cassette placing portion for placing a cassette for storing a semiconductor wafer that is affixed to the top surface of a protective tape mounted to cover the inside opening of a support frame formed in an annular form;
a carrying-out means for carrying the semiconductor wafer out that is placed on the cassette placing portion, stored in the cassette and supported to the support frame by the protective tape;
a temporary placing area for temporarily placing the semiconductor wafer that is carried out from the cassette by the carrying-out means and supported to the support frame by the protective film;
a first conveying apparatus for conveying the semiconductor wafer that is placed on the temporary placing area and supported to the support frame by the protective tape, to a chuck table;
a dicing means for dividing the semiconductor wafer held on the chuck table and supported to the support frame by the protective tape into individual chips;
a second conveying apparatus for conveying the semiconductor wafer that has been divided into individual chips by the dicing means and supported to the support frame by the protective tape, to a cleaning means; and
a third conveying apparatus for conveying the semiconductor wafer that has been cleaned by the cleaning means, divided into individual chips and supported to the support frame by the protective tape, to the temporary placing area, wherein
the third conveying apparatus comprises:
a suction-holding member having a negative pressure chamber which is open at the bottom and an annular contact portion to be contacted to the top surface of the support frame on the under surface, the negative pressure chamber being connected to a suction-source; and
a moving unit for moving the suction-holding member between a first predetermined position and a second predetermined position.

7. The dicing machine according to claim 6, wherein the third conveying apparatus has the function of the first conveying apparatus for conveying the semiconductor wafer that is placed on the temporary placing area and supported to the support frame by the protective tape, to a chuck table.
